(19) United States
(12) Patent Application Publication
(10) Pub. No.: US 2005/0288141 A1
(43) Pub. Date: Dec. 29, 2005

(54) Power transmission chain

(75) Inventors: Takashi Tohara, Osaka (JP); Toshifumi Sato, Osaka (JP)

Correspondence Address: HOWSON AND HOWSON;ONE SPRING HOUSE CORPORATION CENTER, BOX 457, 321 NORRISTOWN ROAD, SPRING HOUSE, PA, 19477, US

(73) Assignee: Tsubakimoto Chain Co., Osaka (JP)

(21) Appl. No.: 11/082,997

(22) Filed: Mar. 17, 2005

(30) Foreign Application Priority Data
Jun. 25, 2004 (JP) 2004-187889

(51) Int. Cl. F16G 13/02; F16G 1/28; F16G 5/20

(52) U.S. Cl. 474/206; 474/202

(57) ABSTRACT

In a newly manufactured roller chain, the pitch measured from one to the other of the two adjacent bushings of any two successive inner links of the chain, is smaller the pitch, measured from one bushing to another of the two bushings on any one of said inner links of the chain, by an amount corresponding to the initial elongation of the chain.

### FIELD OF THE INVENTION

This invention relates to power transmission chains of the kind used in the camshaft drive mechanism of an internal combustion engine, in conveyors, and in power transmission mechanisms of industrial machinery.

### BACKGROUND OF THE INVENTION

Roller chains are widely used as power transmission media for driving one or more camshafts of an internal combustion engine from the engine crankshaft. Metal roller chains are ideal for this purpose, as they exhibit excellent endurance, and are able to meet the increasing demand for high load-bearing capability, high speed operation, and low maintenance. Thus, roller chains have displaced toothed belts in the timing transmissions of more powerful automobile engines.

A typical conventional metal roller chain is an endless chain composed of alternately connected and overlapping inner and outer links. Each inner link comprises a pair of opposed inner plates, each having a pair of bushing holes, and a pair of bushings, each bushing being press-fit in one bushing hole of one of the opposed inner plates and in one bushing hole of the other of plate. Each outer link comprises a pair of opposed outer plates, each having a pair of pin holes, and a pair of pins, each pin being press-fit in one pin hole of one of outer plates and in one pin hole of the other outer plate. The outer plates of each outer link are disposed in overlapping relation with, and on the outsides of, inner plates of adjacent inner links, and each pin of an outer link extends through, and is rotatable in, a bushing of an adjacent inner link. Thus, the inner and outer links are pivotally connected to one another.

In the conventional metal roller chain, the pitch, as measured from one bushing to the next, is uniform over the entire length of the chain. Therefore, the pitch, measured from one to the other of the two adjacent bushings of any two successive inner links of the chain, is the same as the pitch measured from one bushing to another of the two bushings on any one of the inner links of the chain. Such a structure is shown, for example, in “Chain No Ohanashi” (“Chain's story”), by Masataka Nakagome, published by Japanese Standards Association (JSA) on Jan. 20, 1997. The pitch can be measured between bushing centers, or alternatively from a point on the outer circumference of a bushing to a corresponding point on the outer circumference of an adjacent bushing.

The conventional roller chain tends produce a considerable amount of noise when in operation, and frequently fails due to the formation of cracks in its rollers caused by interference with the sprocket teeth with which the chain is in mesh. Objects of this invention are to solve the above-mentioned problems of conventional roller chains, and to provide a roller chain that produces little noise and has a long useful life.

### SUMMARY OF THE INVENTION

Through intensive study, we have found that, in a roller chain, wear on the inner circumferential surface of the bushing, and on the outer circumferential surface of the pin does not take place at a steady rate over time. Rather, such wear initially occurs at a rapid rate over a short time when the newly manufactured chain is first used. Then, shortly after chain is placed into service, the rate of wear of the pin and bushing decreases, and wear proceeds slowly over a long period of time. As a result, the chain typically operates smoothly, and produces little noise, when initially placed into service. However, after a short time, the pitch measured from one of two adjacent bushings of two successive inner links to the other increases due to wear between those bushings and the pins which extend through them. On the other hand, the pitches measured from one bushing to the other in the two bushings of any given link do not change significantly over time. As a result, elongation of the chain occurs quickly during initial operation of the chain, and the elongation is such that the distances between the bushings become alternately small and large. When these variations in pitch occur, the chain no longer meshes smoothly with its sprockets, and generates noise. When the variations in pitch increase still further, interference occurs between the rollers and the heads of the sprocket teeth interfered with a tooth head of the sprocket, which causes the cracks to form in the rollers.

The chain according to the invention is a chain similar in structure to the conventional chain, in that it is composed of alternately connected and overlapping inner and outer links. Each inner link comprises a pair of opposed inner plates, each having a pair of bushing holes, and a pair of bushings, each bushing being press-fit in one bushing hole of one of the opposed inner plates and in one bushing hole of the other of plate. Each outer link comprises a pair of opposed outer plates, each having a pair of pin holes, and a pair of pins, each pin being press-fit in one pin hole of one of outer plates and in one pin hole of the other outer plate. The outer plates of each outer link are disposed in overlapping relation with, and on the outsides of, inner plates of adjacent inner links, and each pin of an outer link extends through, and is rotatable in, a bushing of an adjacent inner link. Thus, the inner and outer links are pivotally connected to one another. However, the chain of the invention differs from the conventional chain in that, in the chain, as manufactured, that is, in the chain before it is placed into service, a first uniform pitch, measured from one to the other of the two adjacent bushings of any two successive inner links of the chain, and a second uniform pitch, measured from one bushing to another of the two bushings on any one of said inner links of the chain are different, the first uniform pitch being smaller than said second uniform pitch, preferably by an amount equal to the initial wear elongation of the chain. Because a large proportion of the overall wear of the chain takes place over a short time when the chain is first placed into service, the pitches tend to equalize in that short time, and remain nearly equal, allowing the chain to operate quietly for a long time, and avoiding early failure due to formation of cracks in the rollers.

Although the invention is primarily useful in a roller chain, that is, a chain in which a roller is provided on each bushing, certain advantages of the invention, such as noise reduction, can be realized in a chain having a similar structure, but in which rollers are not used.

### BRIEF DESCRIPTION OF THE DRAWINGS

FIGS. 1(a) and 1(b) are graphs respectively comparing the pitch difference and noise level of a roller chain in accordance with the invention and a conventional roller chain, as they vary over time;

FIG. 2 is a plan view a roller chain in accordance with the invention;

FIG. 3 is a graph showing elongation over time for a roller chain in accordance with the invention; and

FIG. 4 is a perspective view, partially broken away showing a part of a roller chain in accordance with the invention.

### DETAILED DESCRIPTION OF THE PREFERRED EMBODIMENT

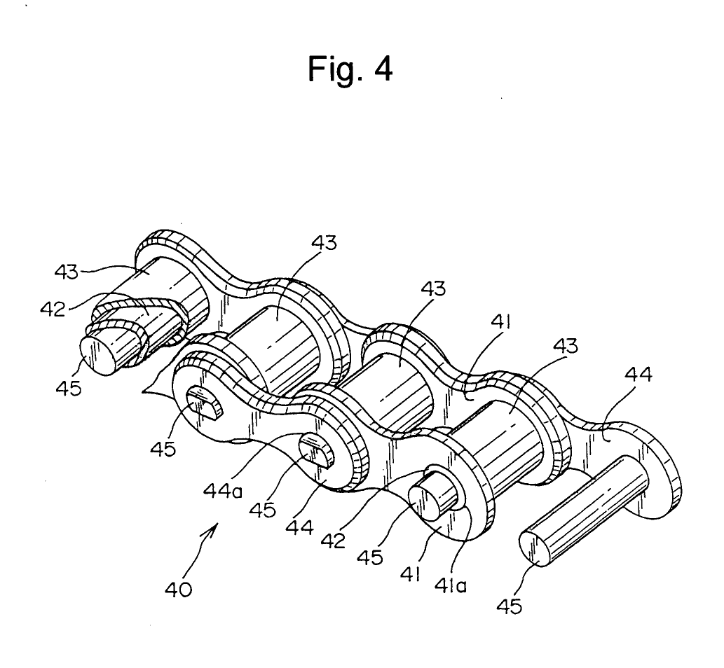

In the chain 40 according to the invention, as depicted in FIG. 4, inner links and outer links are arranged in overlapping relationship along the length of the chain. Each inner link comprises a pair of opposed inner link plates 41, having bushing holes 41a, in which bushings 42 are press fit. Rollers 43 are freely rotatable on the bushings. Each outer link comprises a pair of opposed outer link plates 44, having pin holes 44a in which pins 45 are press fit. Thus, each inner link is composed of two inner link plates 41, two bushings 42 and two rollers 43, and each outer link is composed of two outer link plates 44 and two pins 45. The pins of each outer link extend through bushings of adjacent inner links, and are rotatable therein so that the adjacent links can pivot relative to one another.

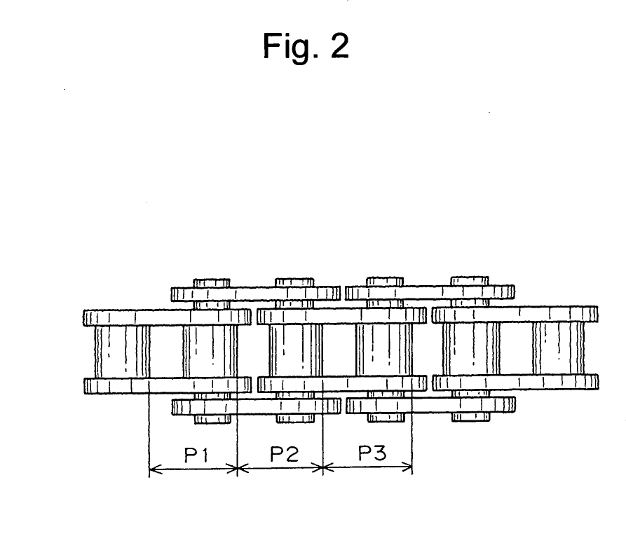

As shown in FIG. 2, in the chain according to the invention the pitches P1 and P3 are equal to each other. Each of these pitches is measured between corresponding points on the two rollers on an inner link, and is equivalent to the pitch as measured between corresponding points on the bushings (not shown in FIG. 2). Pitch P2, however, which is the pitch measured between corresponding points on adjacent rollers (or bushings) of two successive inner links, is smaller than P1 when the chain is initially manufactured, and becomes equal to, or slightly greater than, P1, during a short initial period of use of the chain.

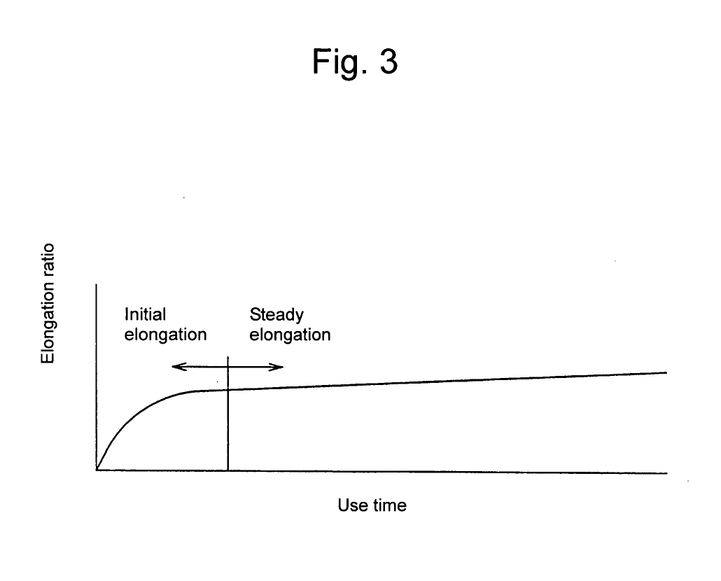

The elongation ratio of a chain is the ratio of the difference between the initial and final length of the chain to the initial length, expressed as a percent. As shown in FIG. 3, (which assumes continuous operation under constant load) the elongation of a chain (as represented by the “elongation ratio”) increases rapidly during an initial elongation interval. However, during this initial interval, the rate of elongation continuously decreases. After the initial interval, the elongation ratio increases slowly, at a constant rate. Thus, the initial elongation may be defined as the amount of elongation that takes place during the time interval between the beginning of the operation of a new chain, and the time at which the rate of elongation becomes constant.

The initial elongation of a chain depends on the materials, dimensions, and shapes of its bushings and pins. In an example of a chain having a nominal pitch of 8 mm, measurements were taken of the elongation due to wear. The initial elongation ratio of the chain was about 0.1%. That is, the chain elongated by 0.08 mm for each link. Accordingly, with the pitches P1 and P3 (FIG. 2) set at 8 mm, and the pitch P2 set at 7.992 mm, the pitch P2 will increase to about 8 mm during the initial elongation, and will remain at a level very near 8 mm for a long time while the chain is in use. The pitch P2 can be easily set by controlling the distance between the pin holes of the outer links.

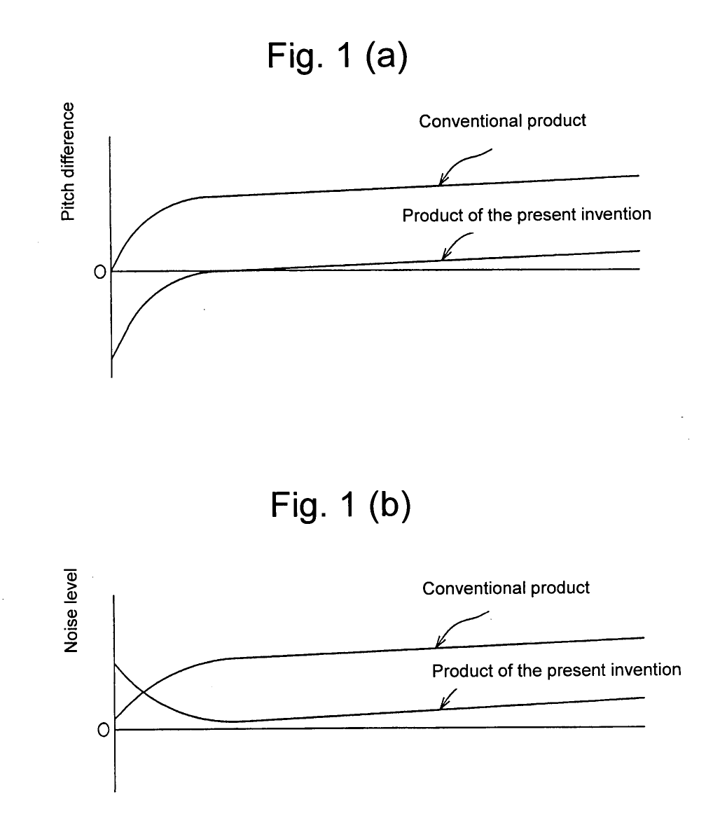

As shown in FIG. 1(a), with a typical conventional chain having a nominal pitch of 8 mm, pitch difference, that is, the difference between the pitch measured from one to the other of adjacent bushings of successive inner links and the pitch measured from one to the other of two bushings of the same inner link, begins at zero, and quickly increases to a value of about 0.08 mm, and then continues to increase, steadily, but very gradually, from 0.08 mm to a value slightly in excess of 0.08 mm. On the other hand, with the chain in accordance with the invention, the pitch difference begins at a value of −0.08 mm, quickly increases to zero, and then steadily, but very gradually from zero to a value slightly in excess of zero. Thus, after the initial elongation takes place in the chain in accordance with the invention, the initial pitch difference is removed, and the pitch difference remains very close to zero over a long time during the useful life of the chain. Accordingly, after the initial elongation, the roller chain of time.

As shown in FIG. 1(b), the noise level produced by the chain in accordance with the invention is initially higher than that produced by the conventional chain. But, as the initial elongation takes place, the noise level produced by the conventional chain increases, while the noise level produced by the chain in accordance with the invention decreases. Thereafter, the noise level produced by the chain in accordance with the invention increases, but only very gradually over a long period of time, as the pitch difference increases at a steady but slow rate.

### INDUSTRIAL APPLICABILITY

The chain in accordance with the invention is a low noise chain especially useful In automotive engines, but also useful in various kinds of conveyors and industrial power transmissions. The chain can be produced without special production equipment and expensive materials, and reduction in noise can be realized simply by controlling the distance between the pin holes of the outer link plates.

1. A newly manufactured power transmission chain comprising alternately connected and overlapping inner and outer links, in which:
each inner link comprises a pair of opposed inner plates, each inner plate having a pair of bushing holes, and a pair of bushings, each bushing being press-fit in one bushing hole of one of said inner plates and in one bushing hole of the other of said inner plates;
each outer link comprises a pair of opposed outer plates, each outer plate having a pair of pin holes, and a pair of pins, each pin being press-fit in one pin hole of one of said outer plates and in one pin hole of the other of said outer plates;
the outer plates of each outer link are disposed in overlapping relation with, and on the outsides of, inner plates of adjacent inner links, and each pin of an outer link extends through, and is rotatable in, a bushing of an adjacent inner link, whereby said inner and outer links are pivotally connected to one another;
the chain has a first uniform pitch, measured from one to the other of the two adjacent bushings of any two successive inner links of the chain, and a second uniform pitch, measured from one bushing to another of the two bushings on any one of said inner links of the chain; and
said first uniform pitch is smaller than said second uniform pitch.

2. A newly manufactured power transmission chain according to claim 1, in which said first uniform pitch is smaller than said second uniform pitch by an amount substantially equal to the initial wear elongation of the chain.

3. A newly manufactured power transmission chain according to claim 1, including a roller rotatably disposed on each said bushing.
